(19) United States
(12) Patent Application Publication
(10) Pub. No.: US 2019/0064932 A1
(43) Pub. Date: Feb. 28, 2019

(54) OPERATION DEVICE

(71) Applicant: KABUSHIKI KAISHA TOKAI RIKA DENKI SEISAKUSHO, Aichi (JP)

(72) Inventor: Hiroshi MISAWA, Aichi (JP)

(21) Appl. No.: 16/079,826

(22) PCT Filed: Feb. 22, 2017
(86) PCT No.: PCT/JP2017/006561

§ 371 Date: Aug. 24, 2018

(30) Foreign Application Priority Data
Mar. 23, 2016 (JP) 2016-058376

(51) Int. Cl. G06F 3/01; G06F 3/041; G06F 3/0488

(52) U.S. Cl. CPC G06F 3/017; G06F 3/04883; G06F 3/0412

(57) ABSTRACT

An operation device includes a detector configured to detect an operation performed on an operation surface, and a determination unit configured to stop the determination of a pinch operation for a predetermined time period if an operation performed with two operating fingers is detected by the detector. The determination unit stops counting the predetermined time period and starts the determination of the pinch operation if a change in a distance between the two operating fingers becomes not less than a first threshold.

### TECHNICAL FIELD

The present invention relates to an operation device.

### BACKGROUND ART

An information display device (operation device) is known that includes: an operation part implemented by a touch panel, a display that displays, on a predetermined screen, a position on the touch panel at which a contact has been detected, by using a predetermined pointer image; and a controller that moves the position of the pointer image in accordance with a user operation, and displays the position of the pointer image on the screen (for example, see Patent Document 1).

This operation device can detect a flick operation or a pinch operation as the user operation.

### CITATION LIST

### Patent Literature

Patent Document 1: JP 2016-18453A

### SUMMARY OF INVENTION

### Technical Problem

The operation device including the operation part that detects a flick operation and a pinch operation can also detect a flick operation performed with two fingers. However, this operation device may falsely determine that the flick operation performed with two fingers is a pinch operation when the distance between these fingers changes during the flick operation.

An object of the invention is to provide an operation device that reduces occurrence of false determinations for flick operations performed with two operating fingers.

### Solution to Problem

An operation device according to an embodiment of the invention includes a detector that detects an operation performed on an operation surface, and a determination unit that stops the determination of a pinch operation for a predetermined time period in the case where an operation performed with two operating fingers is detected by the detector.

### Advantageous Effects of Invention

According to an embodiment of the invention, it is possible to provide an operation device that reduces occurrence of false determinations for flick operations performed with two operating fingers.

### BRIEF DESCRIPTION OF DRAWINGS

FIG. 1A is a schematic diagram illustrating the interior of a vehicle in which an operation device according to an embodiment is installed.

FIG. 1B is a block diagram illustrating a configuration of the operation device.

FIG. 2A is a schematic diagram illustrating an example of a pinch operation performed on an operation surface of the operation device according to the embodiment.

FIG. 2B is a schematic diagram illustrating an example of a flick operation performed with two operating fingers.

FIG. 3A to 3E are graphs illustrating examples of the result of the determination of a pinch operation, detected data related to pinch amounts, and a mask time. FIG. 3A is a graph illustrating an example of the result of the determination of a pinch operation in the case where a mask time according to a comparative example is not set, FIG. 3B is a graph illustrating an example of the relationship between pinch amounts and time in the case where the mask time is not set, FIG. 3C is a graph illustrating an example of the relationship between a mask time according to the embodiment and time, FIG. 3D is a graph illustrating an example of the result of the determination of a pinch operation in the case where the determination of a pinch is stopped during the mask time, and FIG. 3E is a graph illustrating an example of pinch amounts in the case where the mask time is set.

FIGS. 4A to 4E are graphs illustrating examples of the result of the determination of a pinch operation, detected data related to pinch amounts, and a mask time. FIG. 4A is a graph illustrating an example of the result of the determination of a pinch operation in the case where a mask time according to a comparative example is not set, FIG. 4B is a graph illustrating an example of the relationship between pinch amounts and time in the case where the mask time is not set, FIG. 4C is a graph illustrating an example of the relationship between a mask time according to the embodiment and time in the case where counting the mask time is stopped, FIG. 4D is a graph illustrating an example of the result of the determination of a pinch operation in the case where the mask time is stopped, and

FIG. 4E is a graph illustrating an example of pinch amounts in the case where the mask time is stopped.

FIG. 5 is a flowchart illustrating an example of operations performed by the operation device according to the embodiment.

### DESCRIPTION OF EMBODIMENT

### Overview of Embodiment

An operation device according to an embodiment includes a detector that detects an operation performed on an operation surface, and a determination unit that stops the determination of a pinch operation for a predetermined time period in the case where an operation performed with two operating fingers is detected by the detector.

Since the operation device stops the determination of a pinch operation for a predetermined time period, it is possible to reduce occurrence of a false determination that, for a flick operation performed with two operating fingers, a slight change in the distance between the operating fingers indicates a pinch operation, when compared with the case where this configuration is not used.

### Embodiment

Overview of Operation Device 1

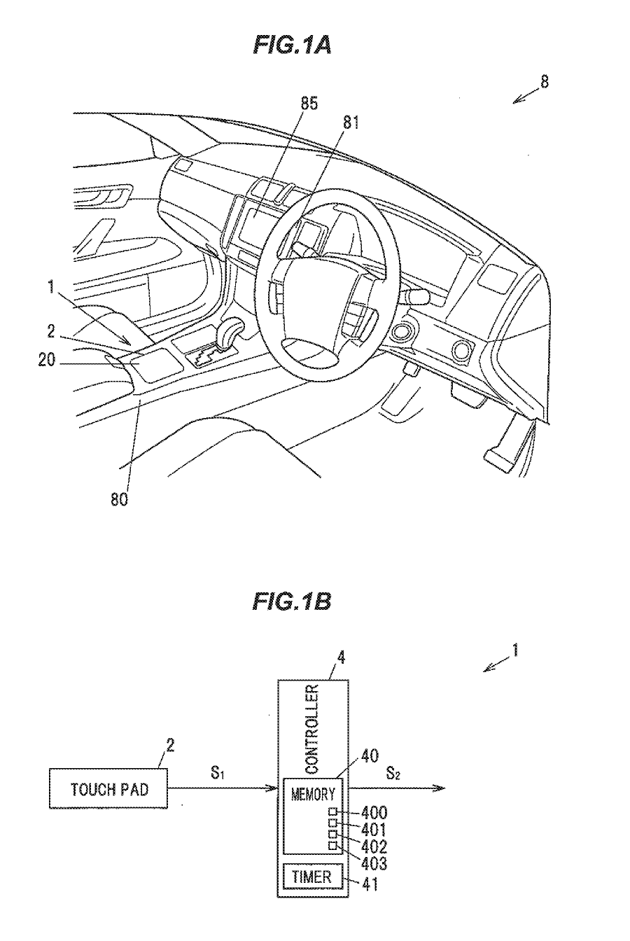

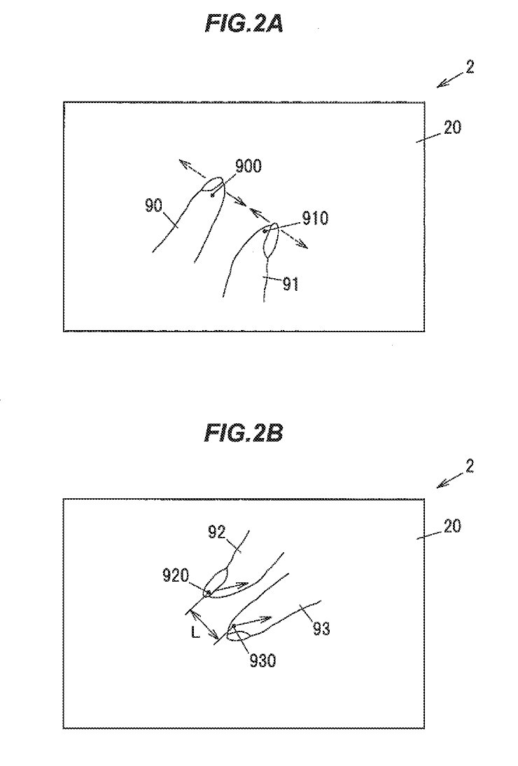

FIG. 1A is a block diagram illustrating the interior of a vehicle in which an operation device according to an embodiment is installed, and FIG. 1B is a block diagram illustrating a configuration of the operation device. FIG. 2A is a schematic diagram illustrating an example of a pinch operation performed on an operation surface of the operation device according to the embodiment, and FIG. 2B is a schematic diagram illustrating an example of a flick operation performed with two operating fingers. In the drawings associated with the following embodiment, ratios between elements in the drawings may be different from the actual ratios. In addition, in FIG. 1B, arrows indicate the flows of primary signals, information, and the like.

An operation device 1 is, for example, installed in a vehicle 8 as illustrated in FIG. 1A. The operation device 1 is, for example, disposed in a floor console 80 extending between a driver's seat and a passenger's seat of the vehicle 8. In addition, the operation device 1 is, for example, configured so that instructions such as the movement of a cursor displayed on a display part of an electronic device, and selection, confirmation, dragging, and dropping of a displayed icon can be performed by operations with a pen or finger having electrical conductivity. A display device 85 disposed in a center console 81 functions as a display part of the electronic device. The present embodiment will describe the operation to be made with a finger (operating finger).

The operation device 1 includes, as illustrated in FIGS. 1A and 1B, a touch pad 2 serving as a detector that detects an operation performed on an operation surface 20, and a controller 4 serving as a determination unit that stops the determination of a pinch operation for a predetermined time period in the case where an operation performed with two operating fingers is detected by the touch pad 2.

Hereinafter, the predetermined time period will be referred to as a mask time 403, and the processing for stopping the determination of a pinch operation will be referred to as mask processing. Thus, when the touch pad 2 detects an operation performed with two operating fingers, the controller 4 performs the mask processing during the mask time 403.

Configuration of Touch Pad 2

The touch pad 2 is, for example, a touch sensor that detects a position, on the operation surface 20, contacted by an operating finger of an operator. A resistive film-type, infrared-type, surface acoustic wave (SAW)-type, or electrostatic capacitance-type touch sensor that can detect a multi-touch can be used as the touch pad 2, for example. The touch pad 2 in the present embodiment is an electrostatic capacitance-type touch sensor, for example.

This touch pad 2 is, for example, configured to detect not only a touch operation or tap operation, but also a pinch operation (pinch-out operation or pinch-in operation), a flick operation, and the like performed with a plurality of operating fingers.

A pinch-out operation is, for example, an operation of enlarging a map image or the like in accordance with a pinch amount, by opening two operating fingers 90 and 91 contacting the operation surface 20, as illustrated in FIG. 2A. A pinch-in operation is, for example, an operation of reducing a map image or the like in accordance with a pinch amount, by closing the two operating fingers 90 and 91 contacting the operation surface 20. A detection point 900 and a detection point 910, illustrated in FIG. 2A, are coordinates of the operating fingers 90 and 91 detected by the touch pad 2.

A flick operation is, for example, an operation of flicking the operation surface 20 with an operating finger. The touch pad 2, for example, detects a flick operation of flicking the operation surface 20 with two operating fingers 92 and 93, as illustrated in FIG. 2B. By performing a flick operation with two operating fingers 92 and 93, an operator can, for example, scroll a map image displayed on a display device 85 in a direction in which the flick operation has been performed. A detection point 920 and a detection point 930 illustrated in FIG. 2B are coordinates of the operating fingers 92 and 93 detected by the touch pad 2.

The touch pad 2 outputs information about coordinates of the detection points, which are points on the operation surface 20 on which the operating fingers have been detected, to the controller 4 as detection information S1. Specifically, in the touch pad 2, for example, a plurality of driving electrodes to which driving signals are supplied, and a plurality of detection electrodes formed between driven driving electrodes and that read electrostatic capacitances are disposed under the operation surface 20 while being insulated from each other. The touch pad 2 obtains the detection points on the basis of electrostatic capacitances obtained from all combinations of the driving electrodes and the detection electrodes, and periodically outputs the detection points as the detection information S1. This period is, for example, 20 ms.

Configuration of Controller 4

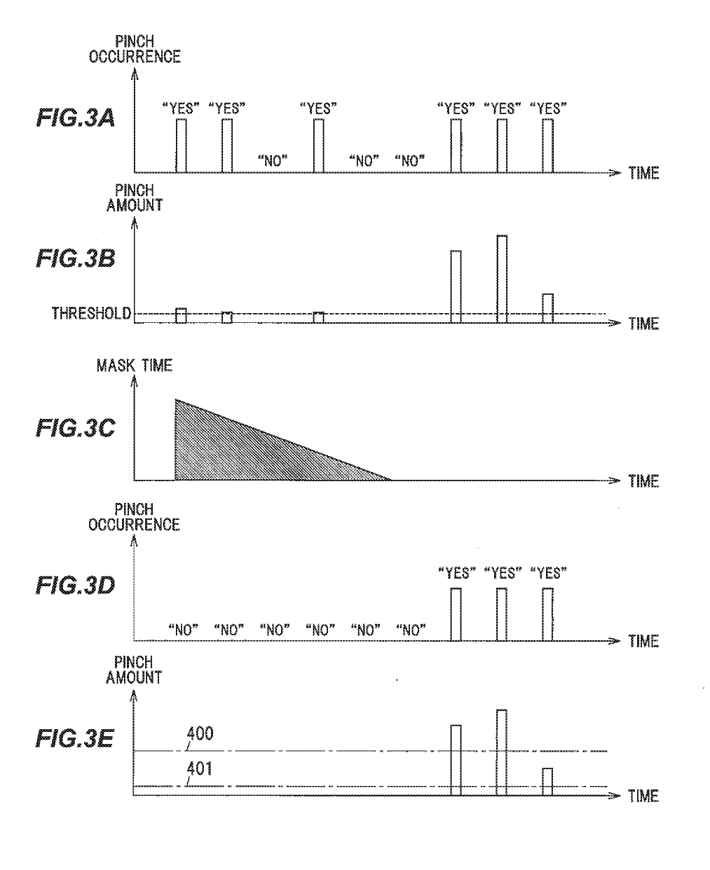

FIG. 3A is a graph illustrating an example of the result of the determination of a pinch operation in the case where a mask time according to a comparative example is not set, FIG. 3B is a graph illustrating an example of the relationship between pinch amounts and time in the case where the mask time is not set, FIG. 3C is a graph illustrating an example of the relationship between a mask time according to the embodiment and time, FIG. 3D is a graph illustrating an example of the result of the determination of a pinch operation in the case where the determination of a pinch is stopped during the mask time, and FIG. 3E is a graph illustrating an example of pinch amounts in the case where the mask time is set.

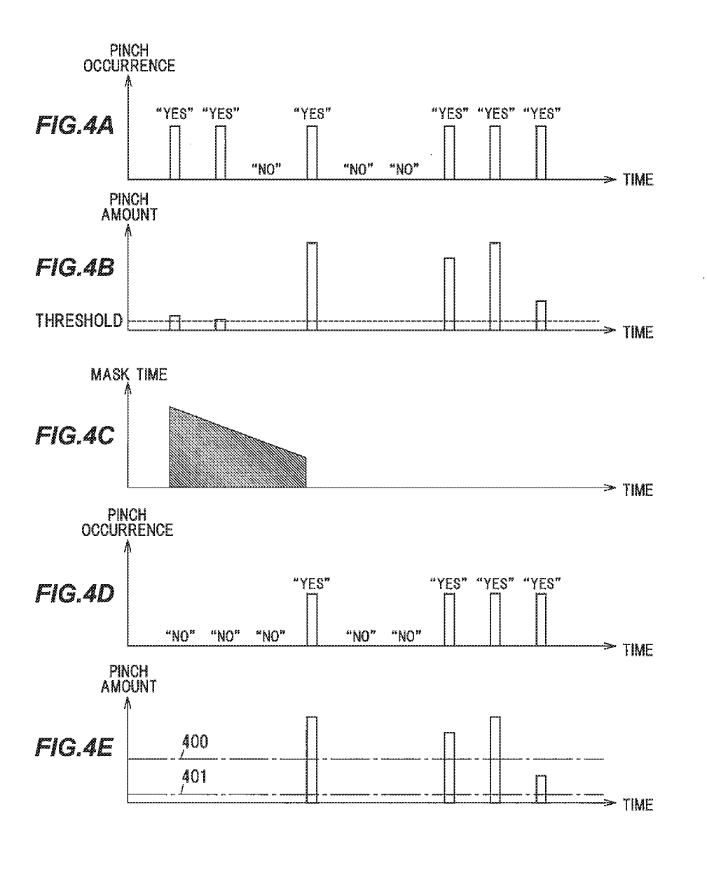

FIG. 4A is a graph illustrating an example of the result of the determination of a pinch operation in the case where a mask time according to a comparative example is not set, FIG. 4B is a graph illustrating an example of the relationship between pinch amounts and time in the case where the mask time is not set, FIG. 0.4C is a graph illustrating an example of the relationship between a mask time according to the embodiment and time in the case where counting the mask time is stopped, FIG. 4D is a graph illustrating an example of the result of the determination of a pinch operation in the case where the mask time is stopped, and FIG. 4E is a graph illustrating an example of pinch amounts in the case where the mask time is stopped.

The vertical axis in FIGS. 3A and 3D, and FIGS. 4A and 4D indicates whether a pinch has occurred. The vertical axis in FIGS. 3B and 3E, and FIGS. 4B and 4E indicates an absolute value of a pinch amount. The vertical axis in FIG. 3C and FIG. 4C indicates the mask time 403. The horizontal axis in FIGS. 3A to 3E and FIGS. 4A to 4E indicates time. In addition, in FIGS. 3A to 3E and FIGS. 4A to 4E, for example, a pinch amount or the like is indicated for each period during which an electrostatic capacitance is read.

The controller 4 is, for example, a microcomputer including a central processing unit (CPU) that carries out computations, processes, and the like on acquired data in accordance with a stored program, a random access memory (RAM) and a read only memory (ROM) that are semiconductor memories, and the like. A program for operations of the controller 4, for example, is stored in the ROM. The RAM is a memory 40 that temporarily stores computation results and the like, for example. In addition, the controller 4 includes a timer 41 for counting the mask time 403.

The memory 40 stores, for example, a mask time threshold 400, a pinch threshold 401, history information 402, and the mask time 403, as illustrated in FIG. 1B.

The mask time threshold 400 is a threshold for determining the end of mask processing during the mask time 403. The mask time threshold 400 is compared with a pinch amount. The pinch amount is a difference between a distance L1 between two operating fingers detected in the last period and a distance L2 detected in this period (=L1−L2). Thus, the controller 4 determines that a pinch-in operation has been performed when the pinch amount is plus, and determines that a pinch-out operation has been performed when the pinch amount is minus. The controller 4 calculates an absolute value of the pinch amount, and in the case where the absolute value of the pinch amount becomes more than or equal to the mask time threshold 400 during the mask processing, determines that a pinch operation has been performed and stops the mask processing.

The pinch threshold 401 is a threshold for determining a pinch operation. This pinch threshold 401 is set to be less than the mask time threshold 400. The controller 4 determines that a pinch operation has been performed when the pinch amount becomes more than or equal to the pinch threshold 401.

In the history information 402, a distance L between detected operating fingers, coordinates of detection points, and the like are stored in chronological order. The controller 4 calculates a pinch amount on the basis of the history information 402.

The mask time 403 is the length of time for which mask processing is performed. The controller 4 activates the timer 41 to count time, and when the mask time 403 passes, stops the timer 41 and stops the mask processing. The mask time 403 is, for example, from 100 to 200 ms. The mask time 403 in the present embodiment is, for example, 150 ms.

There is the case where, as illustrated in FIG. 2B, when an operator performs a flick operation with the two operating fingers 92 and 93, the distance L between the detection point 920 of the operating finger 92 and the detection point 930 of the operating finger 93 slightly changes, and on the basis of this change, it is determined that a pinch operation has been performed.

“Yes” illustrated in FIG. 3A as a comparative example illustrates an example in which a pinch operation is determined with a small pinch amount due to a low threshold for determining a pinch operation, as illustrated in FIG. 3B. Like this, in the case where a pinch operation is determined with a small pinch amount, for example, even when a flick operation is attempted, a map image is enlarged or reduced, or enlarged and reduced repeatedly, which leads to low operability.

In a case where the threshold 401 illustrated in FIG. 3B is set to be high, occurrence of the case where a pinch operation is determined with a small pinch amount decreases, but operability becomes lower due to lower sensitivity for determination. For example, there may be the case where, when an operator makes a fine adjustment to enlarge a map image to a desired size, that operation is not determined. A pinch time threshold 400 for determining a pinch operation during the mask time 403 may be a threshold at the side of an electronic device to which the operation device 1 is connected, or may be set to be lower than that threshold such that sensitivity is increased.

Since the operation device 1 in the present embodiment does not perform the determination of a pinch operation for a predetermined time period (mask time 403), as illustrated in FIGS. 3C to 3E, a pinch operation is not determined with a small pinch amount. In addition, the operation device 1 does not perform the determination of a pinch operation from the time when an operation is started to the time when the mask time 403 passes, thereby making it possible to accurately determine a flick operation or the like on the basis of the history information 402 during that time period.

In addition, while stopping the determination of a pinch operation, the controller 4 outputs operation information S2 in which the amount of change in the distance L between the two operating fingers is zero. Thus, in the case where a pinch operation is determined at the side of an electronic device, the operation device 1, for example, outputs the operation information S2 to the electronic device, such that the determination of a pinch operation is not performed during the mask time 403.

In addition, the controller 4 is configured to stop counting the mask time 403 and start the determination of a pinch operation when the change in the distance L between the two operating fingers becomes more than or equal to the pinch time threshold 400 during the mask time 403.

For example, in the case where pinch amounts as illustrated in FIG. 4A as a comparative example are detected, all of the detected pinch amounts are determined to be “Yes” for pinch occurrence when the threshold is low as illustrated in FIG. 4B. In addition, when the controller 4 sets the mask time 403 and starts mask processing, and stops the determination of a pinch operation until the end of the mask processing, there is a possibility that an operation that is obviously a pinch operation, such as the third pinch amount in FIG. 4B, is masked.

Thus, the controller 4 is configured to detect, by using the mask time threshold 400, an obvious pinch operation performed during the mask time 403. Therefore, when a pinch amount that is more than or equal to the mask time threshold 400 is detected during the mask time 403, as illustrated in FIGS. 4C to 4E, the controller 4 stops the mask processing and determines that a pinch operation has been performed.

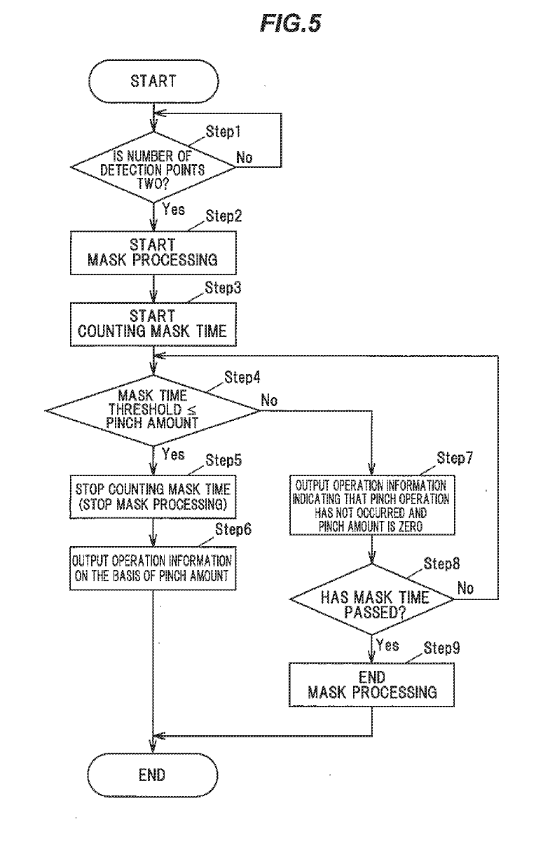

Hereinafter, an example of operations of the operation device 1 will be described according to the flowchart in FIG. 5. Here, only operations related to the determination of a pinch operation will be described.

Operations

When the power source of the vehicle 8 is turned on, the controller 4 of the operation device 1 obtains the detection information S1 periodically from the touch pad 2. The controller 4 monitors, on the basis of the obtained detection information S1, whether the number of detection points is two. Note that the controller 4 performs the determination of a tracing operation or the like in the case where, for example, the number of detection points is one or the number of detection points is more than or equal to three.

In the case where step 1 results in “Yes”, i.e., the number of detection points is two (step 1: Yes), the controller 4 starts mask processing (step 2). For the mask processing, the controller 4 activates the timer 41 to start counting the mask time 403 (step 3).

The controller 4 calculates the distance L on the basis of the two detection points, and stores the distance L in the memory 40 as the history information 402. The controller 4 calculates a pinch amount on the basis of the detection information S1 in the next period. In the case where the pinch amount is greater than or equal to the mask time threshold 400 (step 4: Yes), the controller 4 determines that a pinch operation has been performed, and controls the timer 41 to stop counting the mask time 403, thereby stopping the mask processing (step 5).

Then, the controller 4 generates the operation information S2 based on the pinch amount and outputs the operation information S2 to an electronic device (step 6). This operation information S2 indicates that a pinch operation has been performed. The controller 4 performs an operation of determining a pinch operation on the basis of the detection information S1 of the next period of the period in which the mask processing has been stopped.

Here, in step 4, in the case where the pinch amount is less than the mask time threshold 400 (step 4: No), the controller 4 generates the operation information S2 indicating that a pinch operation has not been performed and that the pinch amount is zero, and outputs the operation information S2 to the electronic device (step 7).

Then, the controller 4 checks the time being measured by the timer 41. In the case where the mask time 403 has passed (step 8: Yes), the controller 4 stops the mask processing (step 9). Then, the controller 4 performs the determination of a pinch operation on the basis of the detection information S1 of the next period and the pinch threshold 401.

In addition, in step 8, in the case where the mask time 403 has not passed (step 8: No), the controller 4 obtains the detection information S1 of the next period, and compares, with the mask time threshold 400, the pinch amount based on the distance L between the operating fingers, which is obtained from the detection information S1, and the distance L of the last period, which is obtained from the history information 402 (step 4).

### Effects of Embodiment

The operation device according to the present embodiment can reduce occurrence of false determinations. Specifically, since the operation device 1 stops the determination of a pinch operation during the mask time 403, it is possible to reduce occurrence of a false determination that, for a flick operation performed with two operating fingers, a slight change in the distance L between the operating fingers indicates a pinch operation, when compared with the case where this configuration is not used. Since the operation device 1 reduces occurrence of false determinations, high operability is provided.

The operation device 1 does not perform the determination of a pinch operation from the time when the detection of an operation performed with two operating fingers is started to the time when the mask time 403 passes, thereby making it possible to accurately determine a flick operation performed with two operating fingers or the like on the basis of the history information 402 during that time period.

The operation device 1 outputs, to an electronic device, the operation information S2 indicating that a pinch amount is zero during the mask time 403. Thus, even in the case where a pinch operation is determined with high sensitivity at the side of the electronic device, it is possible to reduce occurrence of a false determination that an unintended slight change in the distance between the operating fingers indicates a pinch operation. Therefore, the operation device 1 can reduce occurrence of false determinations, and can detect a pinch operation with high sensitivity in accordance with the settings of the electronic device.

Although several embodiments and modifications of the invention have been described above, these embodiments and modifications are merely examples, and the invention according to the claims is not intended to be limited to the embodiments and modifications. Such novel embodiments and modified examples can be implemented in various other forms, and various omissions, substitutions, changes, and the like can be made without departing from the spirit and scope of the invention. In addition, all combinations of the features described in these embodiments and modifications are not necessary means to solve the problem. Furthermore, these embodiments and modified examples are included within the spirit and scope of the invention and also within the scope of the invention described in the claims and equivalents thereof.

### REFERENCE SIGNS LIST

1 Operation device
2 Touch pad
4 Controller
20 Operation surface
90 to 93 Operating finger
400 Mask time threshold
401 Pinch threshold
403 Mask time

1. An operation device, comprising:
a detector configured to detect an operation performed on an operation surface; and
a determination unit configured to stop the determination of a pinch operation for a predetermined time period if an operation performed with two operating fingers is detected by the detector.

2. The operation device according to claim 1, wherein the determination unit stops counting the predetermined time period and starts the determination of the pinch operation if a change in a distance between the two operating fingers becomes not less than a first threshold.

3. The operation device according to claim 1, wherein the determination unit outputs operation information indicating that a change in a distance between the two operating fingers is zero while the determination of the pinch operation is being stopped.

4. The operation device according to claim 2, wherein the first threshold is set to be not more than a threshold of an electronic device to which the operation device is connected.

5. The operation device according to claim 2, wherein, after the predetermined time period has passed, the determination unit determines that the pinch operation has been performed if a change in a distance between the two operating fingers becomes not less than a second threshold.

6. The operation device according to claim 5, wherein the second threshold is set to be less than the first threshold.

7. The operation device according to claim 2, wherein the determination unit outputs operation information indicating that a change in a distance between the two operating fingers is zero while the determination of the pinch operation is being stopped.
